(19) United States
(12) Patent Application Publication
(10) Pub. No.: US 2016/0054531 A1
(43) Pub. Date: Feb. 25, 2016

(54) OPTICAL FIBER CABLE WITH HIGH FRICTION BUFFER TUBE CONTACT

(71) Applicant: Corning Optical Communications LLC, Hickory, NC (US)

(72) Inventors: Adra Smith Baca, Rochester, NY (US); Anne Germaine Bringuier, Taylorsville, NC (US); Jason Clay Lail, Conover, NC (US); Andrey Nikolayevich Levandovskiy, Saint-Petersburg (RU)

(21) Appl. No.: 14/827,728

(22) Filed: Aug. 17, 2015

Related U.S. Application Data
(60) Provisional application No. 62/040,029, filed on Aug. 21, 2014.

(51) Int. Cl. G02B 6/44

(52) U.S. Cl. CPC G02B 6/4432; G02B 6/4434

(57) ABSTRACT

An optical communication cable is provided. The cable includes a cable sheath including an inner surface defining a channel within the cable sheath and a plurality of buffer tubes located in the channel of the cable sheath. Each buffer tube including an outer surface, an inner surface and a channel defined by the inner surface of the buffer tube. The cable includes a plurality of optical fibers located within the channel of each buffer tube. The cable includes a friction structure located on at least one of the inner surface of the sheath and the outer surfaces of each of the plurality of buffer tubes and the friction created by the friction structure provides resistance to cable deformation under loading, such as crush loading.

### PRIORITY APPLICATION

This application claims the benefit of priority under 35 U.S.C. §119 of U.S. Provisional Application No. 62/040,029, filed on Aug. 21, 2014, the content of which is relied upon and incorporated herein by reference in its entirety.

### BACKGROUND

The disclosure relates generally to optical communication cables and more particularly to optical communication cables having increased friction between cable elements, for example optical fiber carrying buffer tubes. Optical communication cables have seen increased use in a wide variety of electronics and telecommunications fields. Optical communication cables contain or surround one or more optical communication fibers. The cable provides structure and protection for the optical fibers within the cable.

### SUMMARY

One embodiment of the disclosure relates to a crush resistant optical communication cable. The crush resistant optical communication cable includes a cable body that has an inner surface defining a channel within the cable body. The crush resistant optical communication cable includes a first core element located in the channel of the cable body and a second core element located in the channel of the cable body. The first core element includes a first tube including an outer surface, an inner surface and a channel defined by the inner surface of the first tube and an optical fiber located within the channel of the first tube. The second core element includes a second tube including an outer surface, an inner surface and a channel defined by the inner surface of the second tube and optical fiber located within the channel of the second tube. The crush resistant optical communication cable includes an elongate rod located in the channel of the cable body that includes an outer surface. The crush resistant optical communication cable includes a friction structure located within the channel of the cable increasing friction between at least two of the inner surface of the cable body, the outer surface of the first tube, the outer surface of the second tube and the outer surface of the elongate rod. The friction structure increases friction such that radial displacement of the elongate rod is less than 1.0 mm and greater than 0.2 mm under 150 N/cm loading as determined by the Wringer Test.

An additional embodiment of the disclosure relates to an optical communication cable. The optical communication cable includes a cable body including an inner surface defining a channel within the cable body. The optical communication cable includes a first buffer tube located in the channel of the cable body, and the first buffer tube includes an outer surface, an inner surface and a channel defined by the inner surface of the first buffer tube. The optical communication cable includes a first plurality of optical fibers located within the channel of the first buffer tube. The optical communication cable includes a second buffer tube located in the channel of the cable body, and the second buffer tube includes an outer surface, an inner surface and a channel defined by the inner surface of the second buffer tube. The optical communication cable includes a second plurality of optical fibers located within the channel of the second buffer tube. The optical communication cable includes a friction structure located within the channel of the cable body that causes friction between at least two of the inner surface of the cable body, the outer surface of the first buffer tube, and the outer surface of the second buffer tube. The friction structure causes friction such that the minimum radial distance between opposing sections of the inner surfaces of the first and second buffer tubes is greater than 0.5 mm under 150 N/cm loading as determined by the Wringer Test. The first buffer tube and second buffer tube are not adhered together such that the second buffer tube is permitted to move relative to the first buffer tube within the channel.

An additional embodiment of the disclosure relates to an optical communication cable. The optical communication cable includes a cable sheath including an inner surface defining a channel within the cable sheath. The optical communication cable includes a plurality of buffer tubes located in the channel of the cable sheath, and each buffer tube includes an outer surface, an inner surface and a channel defined by the inner surface of the buffer tube. The optical communication cable includes a plurality of optical fibers located within the channel of each buffer tube. The optical communication cable includes a friction structure located on at least one of the inner surface of the sheath and the outer surfaces of each of the plurality of buffer tubes. The friction structure creates a coefficient of kinetic friction between the inner surface of the cable sheath and the outer surfaces of the buffer tubes greater than 0.15.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of an optical fiber cable according to an exemplary embodiment.

FIG. 2 is a detailed perspective view of a core element of the cable of FIG. 1 having a high friction outer surface according to an exemplary embodiment.

FIG. 3 is a detailed perspective view of a core element of the cable of FIG. 1 having a high friction outer surface according to another exemplary embodiment.

FIG. 4 is a detailed perspective view of a core element of the cable of FIG. 1 having a high friction outer surface according to another exemplary embodiment.

FIG. 5 is a detailed perspective view of a core element of the cable of FIG. 1 having a high friction outer surface according to another exemplary embodiment.

FIG. 6 is a cross-sectional view of the cable of FIG. 1 showing a high friction inner jacket surface according to an exemplary embodiment.

FIG. 7 is a cross-sectional view of the cable of FIG. 1 showing a high friction inner binder surface according to an exemplary embodiment.

FIG. 8 is a cross-sectional view of the cable of FIG. 1 prior to application of compression forces according to an exemplary embodiment.

FIG. 9 is a cross-sectional view of the cable of FIG. 1 showing deformation under compression forces according to an exemplary embodiment.

FIG. 10 is a cross-sectional view of the cable of FIG. 1 showing deformation under compression forces according to another exemplary embodiment.

FIG. 11A is a graph showing projected buffer tube deformation at various loading force levels for different interface friction levels under a composite tension bending test.

FIG. 11B is a graph showing projected central strength rod displacement at various loading force levels for different interface friction levels under a composite tension bending test.

FIG. 12 is a graph showing the relationship between cable crush resistance and internal cable interface friction according to an exemplary embodiment.

FIG. 13 is a schematic view of a tensioning device for testing crush-resistance of a cable under a composite tension bending test, such as the Wringer Test.

### DETAILED DESCRIPTION

Referring generally to the figures, various embodiments of an optical communication cable (e.g., a fiber optic cable, an optical fiber cable, etc.) are shown. In general, the cable embodiments disclosed herein include one or more optical fibers containing core elements. In various embodiments, the optical fibers containing core elements include a tube (e.g., a buffer tube) surrounding one or more optical transmission elements (e.g., optical fiber) located within the tube. In general, the tube acts to protect the optical fibers under the wide variety of forces that the cable may experience during installation, handling or in use. In particular, the forces the cable may experience includes compression loading (e.g., compression bending, radial crush, etc.).

The optical cable embodiments discussed herein include a friction structure that creates friction between the buffer tubes and other buffer tubes, between buffer tubes and an exterior cable layer (such as the inner surface of the cable jacket), and/or between buffer tubes and a central strength rod. By increasing friction between one or more of these components the relative displacement of these components may be reduced as radial forces are experienced by the buffer tubes, which in turn may help maintain the contact or interface surface areas between cable components under various types of loading. It is believed that by maintaining the amount of surface area contact between cable components, radial forces are more evenly distributed through cable components, and thereby the deformation experienced by the buffer tubes and the potential for damage to the optical fibers with the buffer tubes is reduced.

Further, by utilizing high friction interfaces as discussed herein rather than the rigid bonding or adhering together of core elements that is typical in some crush-resistant cable designs, the present cable is relatively flexible because of the unbonded nature of the core elements. For example, by utilizing high friction without adhering together of the cable core elements, the cable embodiments discussed herein permit some relative movement between core elements which may provide better flexibility as compared to a cable in which core elements are bonded together, such as with an adhesive. In addition, by utilizing high friction interfaces to improve crush resistances, smaller and thinner buffer tubes may be used within the present cable design without losing crush-performance, while at the same time resulting in a lighter, smaller and more flexible cable.

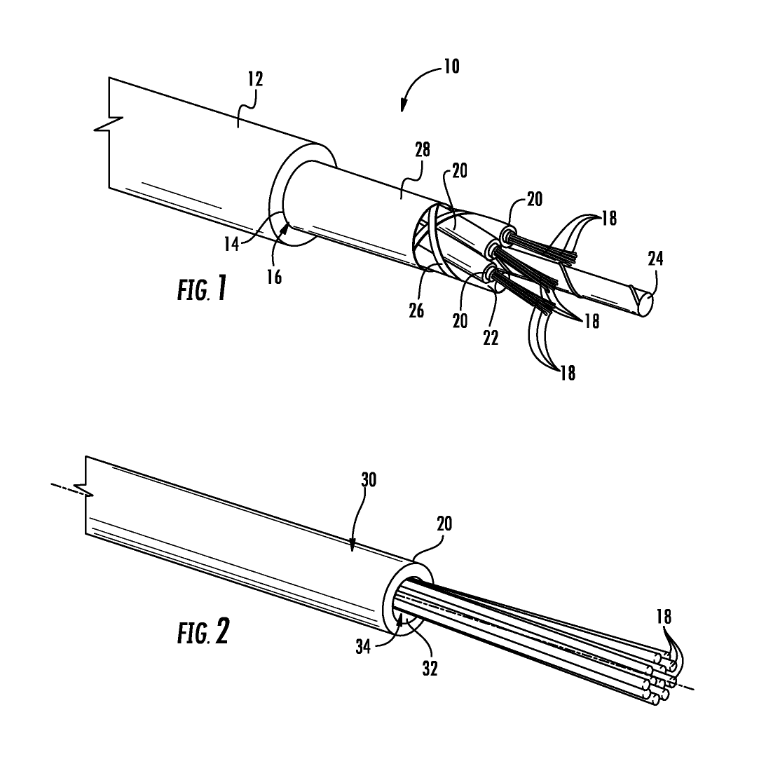

Referring to FIG. 1, an optical communication cable, shown as cable 10, is shown according to an exemplary embodiment. Cable 10 includes a cable body, shown as cable jacket 12, having an inner surface 14 that defines a channel, shown as central bore 16. Cable jacket 12 is an example of one type of cable sheath, and in this embodiment, cable jacket 12 is a cable sheath that defines the outer surface of cable 10. A plurality of optical transmission elements, shown as optical fibers 18, are located within bore 16. Generally, cable 10 provides structure and protection to optical fibers 18 during and after installation (e.g., protection during handling, protection from elements, protection from vermin, etc.).

In the embodiment shown in FIG. 1, cable 10 includes a plurality of core elements located within central bore 16. A first type of core element is an optical transmission core element, and these core elements include bundles of optical fibers 18 that are located within tubes, shown as buffer tubes 20. One or more additional core elements, shown as filler rods 22, may also be located within bore 16. Filler rods 22 and buffer tubes 20 are arranged around an elongate rod, shown as central strength member 24, that is formed from a material such as glass-reinforced plastic or metal (e.g., steel).

In the embodiment shown, filler rods 22 and buffer tubes 20 are shown in a helical stranding pattern, such as an SZ stranding pattern. Helically wound binders 26 are wrapped around buffer tubes 20 and filler rods 22 to hold these elements in position around strength member 24. In some embodiments, a thin-film, extruded sheath may be used in place of binders 26. A barrier material, such as water barrier 28, is located around the wrapped buffer tubes 20 and filler rods 22. In various embodiments, cable 10 may include a reinforcement sheet or layer, such as a corrugated armor layer, between layer 28 and jacket 12, and in such embodiments, the armor layer generally provides an additional layer of protection to optical fibers 18 within cable 10, and may provide resistance against damage (e.g., damage caused by contact or compression during installation, damage from the elements, damage from rodents, etc.).

In various embodiments, buffer tubes 20 are formed from an extruded thermoplastic material. In one embodiment, buffer tubes 20 are formed from a polypropylene (PP) material, and in another embodiment, buffer tubes 20 are formed from a polycarbonate (PC) material. In other embodiments, buffer tubes 20 are formed from one or more polymer material including polybutylene terephthalate (PBT), polyamide (PA), polyoxymethylene (POM), poly(ethene-co-tetrafluoroethene) (ETFE), etc.

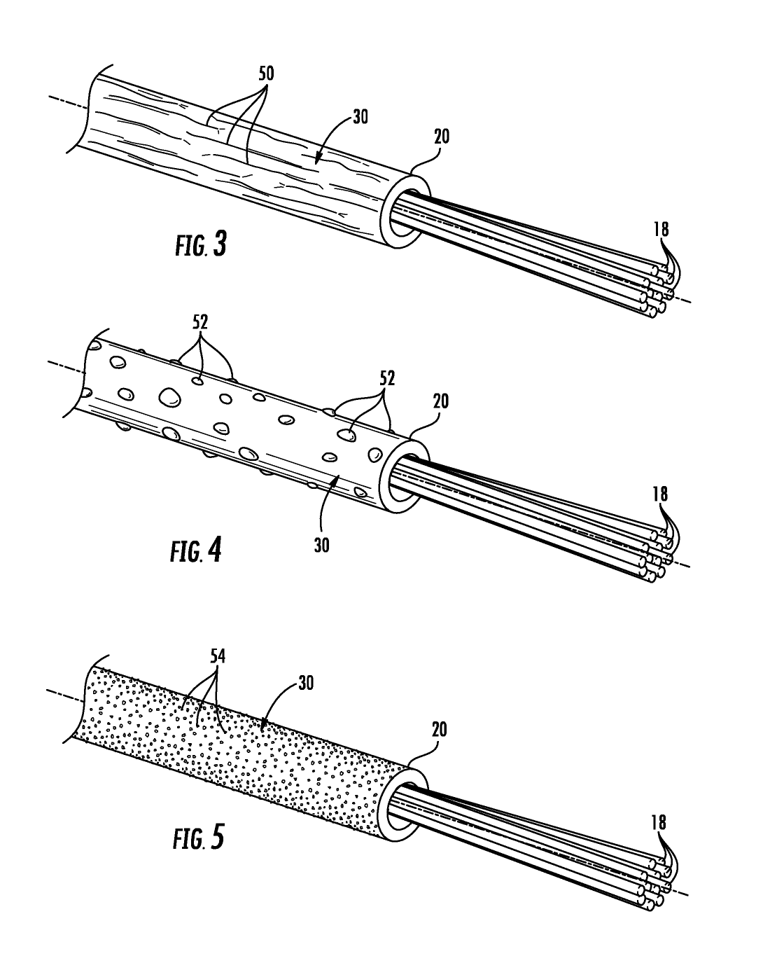

Referring to FIG. 2, a buffer tube 20 and optical fibers 18 are shown according to an exemplary embodiment. Buffer tube 20 includes an outer surface 30 that defines the exterior surface of the buffer tube and an inner surface 32 that defines a channel, shown as central bore 34. Optical fibers 18 are located within central bore 34. In various embodiments, optical fibers 18 may be loosely packed within buffer tube 20 (e.g., a “loose buffer”), and in such embodiments, cable 10 is a loose tube cable. In various embodiments, central bore 34 may include additional materials, including water blocking materials, such as water swellable gels.

As noted above, in various embodiments, cable 10 includes a friction structure that acts to increase friction between the various components of cable 10 to improve crush-performance. In general, the friction structure is a structure located within bore 16 of cable 10 that increases friction between adjacent structures within cable 10, such as between adjacent buffer tubes 20, buffer tubes 20 and strength member 24, and/or buffer tubes 20 and inner surface 14 of cable jacket 12. In various embodiments, the friction structures disclosed herein increase friction between elements within cable jacket 12 without fixing or bonding together the elements, and without this type of binding, the internal components are permitted to move relative to each other (e.g., move more than 10 micrometers, 50 micrometers or 100 micrometers relative to each other). Increasing friction without bonding provides for improved crush-performance, as shown below, while still allowing buffer tubes 20 to be individually accessed (e.g., mid-span access) and split from cable 10 with relative ease.

In various embodiments, as shown in FIGS. 2-5, the friction structure is a structure or material located along outer surfaces 30 of buffer tubes 20 that raises the friction between buffer tubes 20 and other structures within cable 10. As shown in FIG. 2, buffer tubes 20 may have a substantially smooth outer surface, but may be made from a material that has material properties that provide friction at a sufficient level to provide the crush-resistance as discussed herein. In this embodiment, the friction structure is the high friction material that forms outer surfaces 30 of buffer tubes 20.

Referring to FIG. 3, in other embodiments, the friction structure of cable 10 is a series of grooves, shown as grooves 50, that are formed in outer surfaces 30 of buffer tubes 20. In the embodiment shown, grooves 50 form a random or irregular, nonrepeating pattern along outer surface 30. In various embodiments, at least some of grooves 50 are relatively shallow depressions that extend in the direction of the longitudinal axis of buffer tubes 20. In various embodiments the depths of grooves 50 (e.g., the radial distance between lowest point of the groove and the outer most surface of the buffer tube) is between 0.05 mm and 0.1 mm. In various embodiments, grooves 50 increase friction by generally increasing the contact surface area within jacket 12, and also increase friction relative to similarly configured adjacent buffer tubes 20 by catching and engaging grooves 50 on the adjacent buffer tubes 20. In various embodiments, buffer tubes 20 may also include ridges that extend out from outer surface 30 in place of or in addition to grooves 50.

Grooves 50 may be formed in a variety of suitable ways. In one embodiment, grooves 50 may be formed by mechanically roughening or scoring outer surface 30 to form grooves 50. In another embodiment, grooves 50 may be formed by hot-melt fracture during extrusion of the buffer tubes.

Referring to FIG. 4, in other embodiments, the friction structure of cable 10 is a series of projections, shown as projections 52, that extend from outer surface 30. In various embodiments, the height of projections 52 (e.g., the radial distance between the outermost surface of a projections 52 and the outermost surface buffer tube 20) is between 0.1 mm to 0.2 mm. In various embodiments, projections 52 have a width and/or length between 0.1 mm and 0.2 mm. In various embodiments, projections 52 are made from a polymer material that is different from the polymer material that forms buffer tubes 20. In some such embodiments, projections 52 are formed from a rubber-like, hot-melt adhesive material that is deposited on and bonded to outer surface 30 of buffer tubes 20. In such embodiments, the material of projections 52 is a material that has a higher coefficient of friction relative to the adjacent structures within cable 10 than the material of buffer tubes 20, and thereby raises friction. While FIG. 4 shows projections 52 as discreet relatively spherical or ovoid bumps, projections 52 may be other shapes. For example, in some embodiments, projections 52 may be elongated fibrils extending outward from outer surface 30. In another embodiment, projections 52 may be in the form of a web-like pattern extending outward from outer surface 30.

In various embodiments, projections 52 may be formed by spraying melted droplets or fibrils of the material that forms projections 52 onto outer surface 30 of buffer tubes 20. The droplets then cool forming projections 52. In various embodiments, the material forming projections 52 may be sprayed onto buffer tubes 20 following buffer tube extrusion and in a specific embodiment, may be sprayed onto buffer tubes 20 during the stranding operation. In one embodiment, the material of projections 52 may be a swellable hot-melt material that is applied to buffer tubes using fiberized spray equipment. In one such embodiment, this material is applied during the jacketing step, but prior to jacket extrusion. In one such embodiment, this bonds buffer tubes 20 to jacket 12 which would allow acceptable attenuation values of the temperature range of −40 degrees C. to 70 degrees C. The use of swellable hot-melt material may also provide a water blocking function such that water blocking tape may not be needed for a cable intended for an outdoor application.

Referring to FIG. 5, in other embodiments, the friction structure of cable 10 is a series of grit particles, shown as particles 54, embedded in the material of buffer tubes 20. In this embodiment, particles 54 are generally hard and rough irregularly shaped structures projecting from outer surface 30 in an irregular or random pattern. In general, particles 54 increase friction similar to sand paper by engaging with surfaces adjacent to buffer tubes 20 and/or by providing a slip-stick interaction with particles 54 on adjacent buffer tubes.

In various embodiments, particles 54 may be embedded in buffer tubes 20 while the material of buffer tubes 20 remains soft after extrusion. In other embodiments, the material of buffer tubes 20 may be reheated and softened to accept particles 54 in a formation step following buffer tube extrusion. In another embodiment, particles 54 may be adhered to outer surface 30 of buffer tubes 20 using adhesive material. Particles 54 may be mica, silica, superabsorbent polymer or any other suitable grit particle with particle size ranging from 200 to 800 microns.

In various embodiments, instead of or in addition to the friction structure being located on outer surfaces 30 of buffer tubes 20, the friction structure of cable 10 may include friction increasing materials or structures located on other surfaces or components of cable 10 that contact buffer tubes 20. In various embodiments, any of the friction structures shown in FIGS. 2-5 may be formed or located on any other surface or component of cable 10.

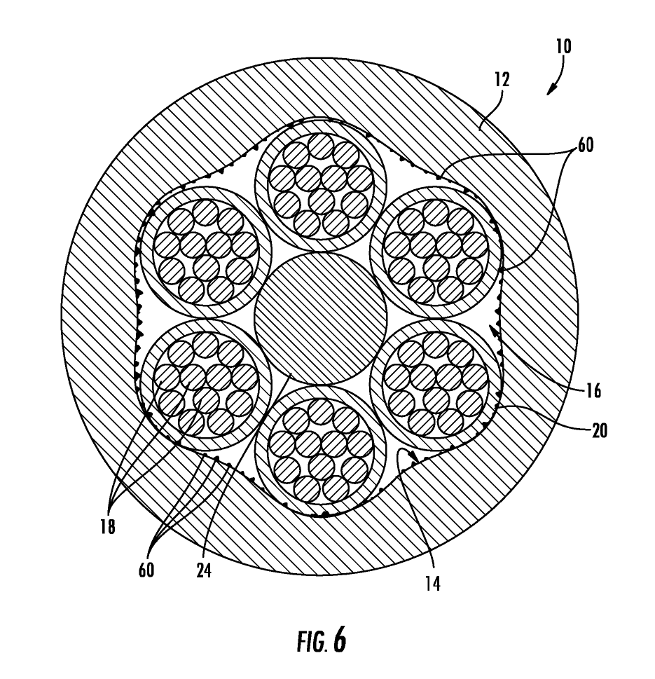

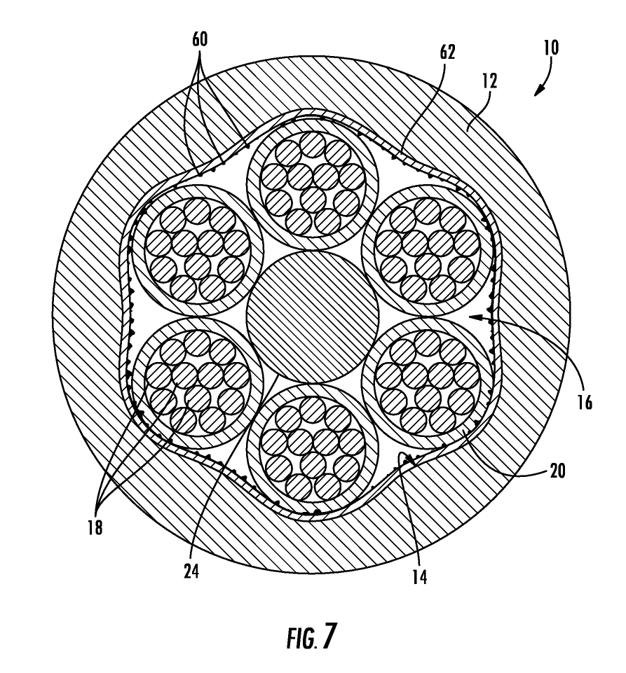

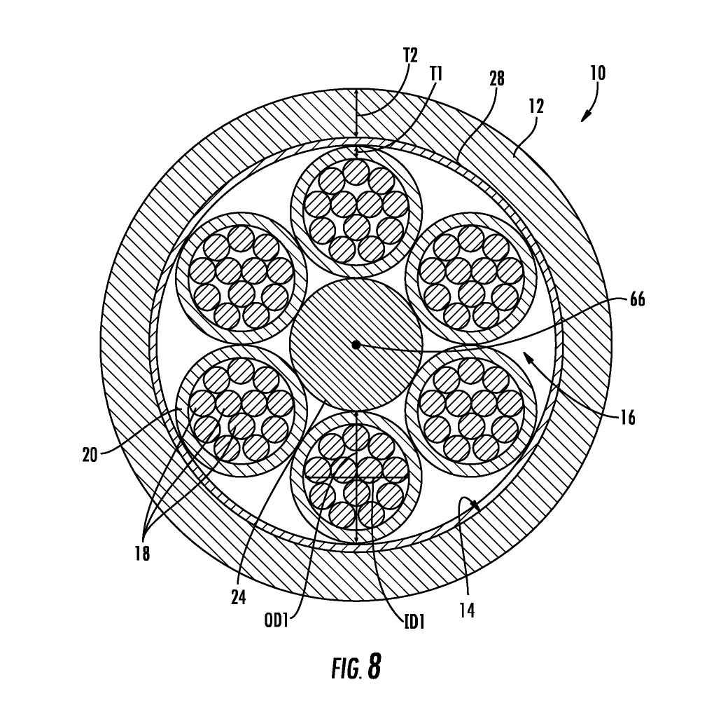

For example, referring to FIG. 6, in one embodiment a friction increasing structure, shown as grit particles 60, are embedded along inner surface 14 of cable jacket 12. Grit particles 60 are generally hard and rough irregularly shaped structures projecting from inner surface 14, like particles 54 discussed above. In general, particles 60 increase friction similar to sand paper by engaging with the outer surfaces 30 of buffer tubes 20. In one embodiment, inner surface 14 of jacket 12 includes grit particles 60 and outer surfaces 30 of buffer tubes 20 include grit particles 54 (as shown in FIG. 5) and in this embodiment, particles 60 and 54 provide a slip-stick interaction raising friction between inner surface 14 of jacket 12 and outer surface 30 of buffer tubes 20.

In various embodiments, particles 60 may be embedded in inner surface 14 of jacket 12 while the material of jacket 12 remains soft after extrusion. In other embodiments, the material of jacket 12 may be reheated and softened to accept particles 60 in a formation step following jacket extrusion. In another embodiment, particles 60 may be adhered to inner surface 14 using an adhesive material. Particles 60 may be mica, silica, or any other suitable grit particle.

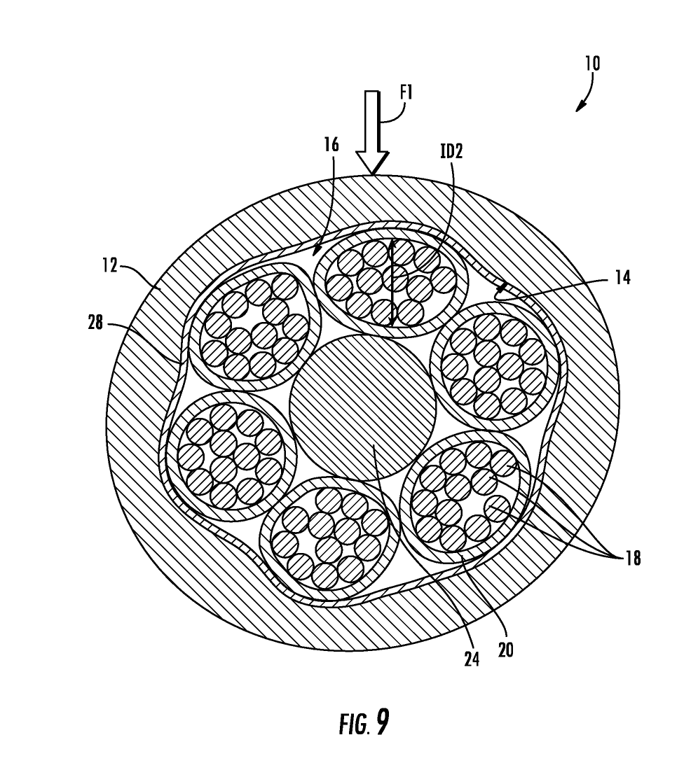

As another example, referring to FIG. 7, cable 10 may include a cable sheath, shown as extruded thin film binder 62, located around and surrounding buffer tubes 20. In various embodiments, binder 62 is as a thin (e.g., less than 200 micrometers, less than 150 micrometers or less than 100 micrometers) polymer sheath that acts to bind together buffer tubes 20 in a stranded pattern (such as an SZ stranding pattern). In various embodiments, binder 62 is extruded around buffer tubes 20 after stranding, and binder 62 cools to provide an inwardly directed force on to buffer tubes 20. Similar to the embodiment of FIG. 6, grit particles 60 may be embedded in binder 62 such that particles 60 extend from the inner surface of binder 62, as shown in FIG. 7. In this arrangement, similar to the embodiment of FIG. 6, grit particles 60 act to increase friction relative to buffer tubes 20.

Referring to FIGS. 8-12, crush performance under various radial loads and the increase in crush-resistance provided by the various friction structures discussed herein is described in more detail. As shown in FIG. 8, cable 10 is shown in the unloaded state. As shown in FIG. 8, prior to application of radial forces, the cross-section shapes of buffer tubes 20 and inner surface 14 are substantially undistorted and, in the embodiment shown are substantially circular in shape. In addition, prior to radial loading, central strength member 24 is located generally in the center of bore 16, and in general, the center point 66 of central strength member 24 resides substantially at the center point of bore 16 in the plane of the cross-section of FIG. 8.

In general as noted above, cable 10, by inclusion of one or more of the friction structures discussed above, may utilize buffer tubes 20 that are thinner and/or smaller than is typical while maintaining sufficient crush-performance through increased friction as discussed herein. As shown in FIG. 8, prior to distortion under radial forces, buffer tubes 20 have an outer diameter, shown as OD1, that is between 1.8 mm and 2.4 mm, and more specifically is between 2 mm and 2.25 mm. In addition, prior to distortion under radial forces, buffer tubes 20 have an inner diameter, shown as ID1, that is between 1.2 mm and 1.9 mm, specifically between 1.5 mm and 1.7 mm and more specifically between 1.55 mm and 1.6 mm. In addition, prior to distortion under radial forces, buffer tubes 20 have a thickness, shown as T1, that is between 0.6 mm and 0.15 mm, specifically between 0.5 mm and 0.25 mm and more specifically between 0.45 mm and 0.3 mm. In addition, in various embodiments, jacket 12 has a thickness, shown as T2, that is between 2 mm and 0.5 mm, specifically between 1.8 mm and 1.0 mm and more specifically between 1.5 mm and 1.2 mm. In some such embodiments, jacket 12 is relatively thin providing flexibility to cable 10, while allowing the friction structure of cable 10 to provide substantial crush-resistance.

Referring to FIG. 9, an illustration of cable 10 under radial loading, designated by arrow F1, is shown according to an exemplary embodiment. In various embodiments, F1 represents a crush-force that may be applied to the outer surface of cable jacket 12. As shown in FIG. 9, as F1 increases, inner surface 14 of jacket 12 and buffer tubes 20 are distorted from the shapes shown in FIG. 8. As buffer tubes 20 are distorted under the crush-force, buffer tubes 20 have a minimum internal dimension or diameter, shown as ID2, which may be measured for a given level of radial force, F1. As discussed below, one measure of crush-resistance is the maximum decrease in the radial distance between opposing sections of the inner surfaces of buffer tubes 20, which is the maximum ID decrease shown as the difference between ID1 and ID2, experienced by buffer tubes 20 for a given force F1 under various standard crush-test procedures.

It is believed that by increasing friction at buffer tube interfaces within cable 10, the amount of shifting between interface contact points is reduced under loading, which provides for larger contact surface areas between buffer tubes 20 and/or jacket 12, which in turn improves crush performance. In general, it is believed that in low-friction cables, without a friction structure as discussed herein, buffer tubes 20 are permitted to slide past the midpoint of one another, allowing non-uniform distribution of the radial load over the cable structure. Depending on the point in the cable where the load is applied (e.g., at the SZ strand or the reversal), the deformation and sliding can involve two or four buffer tubes. In various embodiments, the friction structure discussed herein reduces or eliminates this slippage allowing buffer tubes 20 to interact with each other and adjacent structures within the cable over a larger area and effectively reinforce one another during crush events.

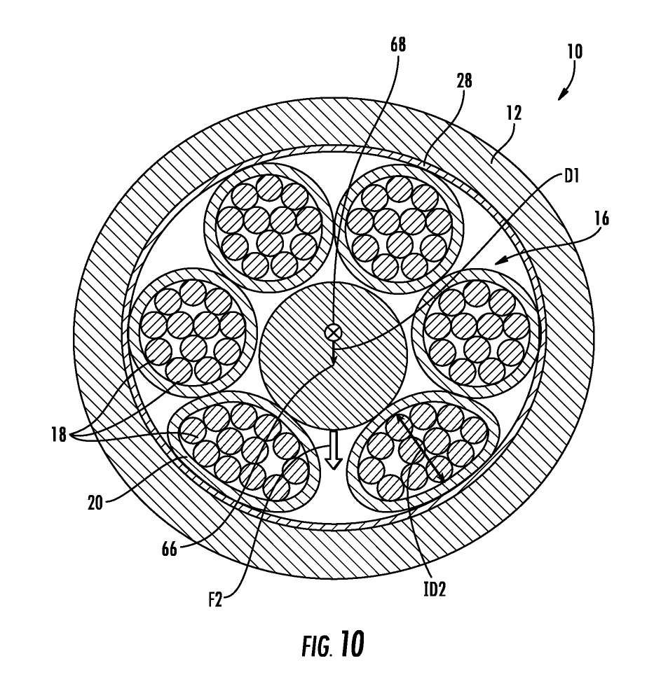

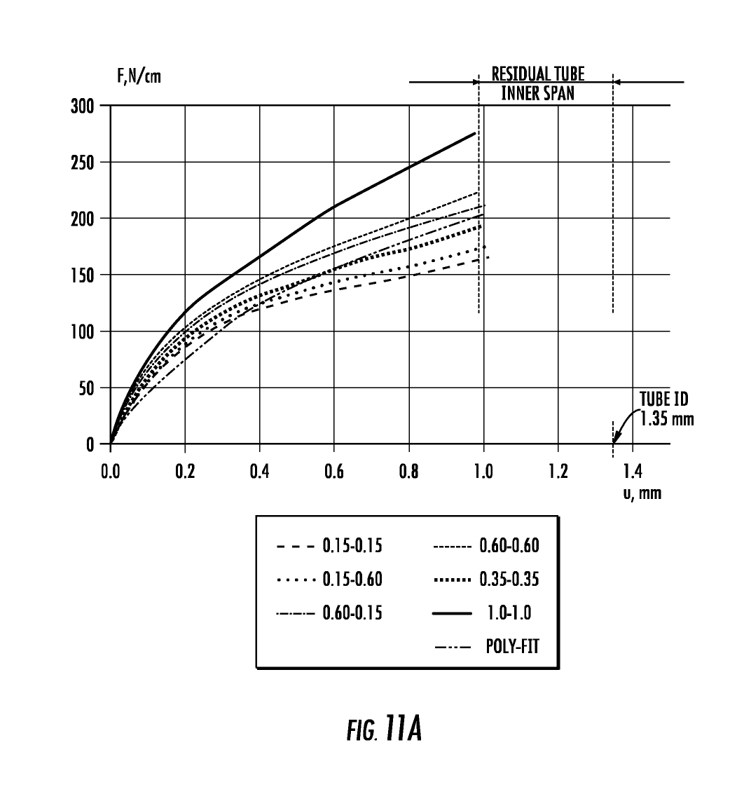

Referring to FIG. 10, an illustration of cable 10 under radial loading, designated by arrow F2, is shown according to an exemplary embodiment. FIG. 10 illustrates radial loading under a standard composite tension bending test, such as the Wringer Test as described below and in more detail in Christopher M. Quinn & David A. Seddon, Installation of Fiber Optic Cable Outside the Box, in Proceedings of the 60th IWCS Conference 350 (International Wire & Cable Symposium, 2011) (hereinafter referred to as the “Wringer Test”) which is incorporated herein by reference in its entirety.

In general, referring to FIG. 13, the Wringer Test involves pulling cable 10 in tension bent 90 degrees around a tensioning device 100 curved surface, such as test wheel 102, having a radius set by the test standard. Tensioning device 100 is designed to simulate stresses that occur on a cable during installation, when a cable is under tension and going over a bend from a sheave. Tensioning device 100 is further referred as the “composite tension bending test” apparatus. The device is controlled by a calibrated tension measurement wheel at the top of the apparatus and allows line speeds of 5 m/min up to 30 m/min, with 10 m/min being a typical installation speed. Thus, under this type of crush force, central strength member 24 tends to be displaced in the direction of arrow F2. Under this loading, at least some of buffer tubes 20 and inner surface 14 of jacket 12 tends to be distorted as central strength member 24 is pulled in the direction of F2.

As discussed in more detail below, one measure of crush-resistance under a composite tension bending test, such as the Wringer Test, is the amount of displacement of central strength member 24 shown by displacement, Dl, in FIG. 10. As shown Dl, is determined as the difference between the position of center point 66 of central strength member 24 under loading of F2 and the position of center point 66 unloaded, represented by point 68 in FIG. 10. In addition to strength member displacement, another measure of crush-resistance under a composite tension bending test, such as the Wringer Test, is the maximum decrease in the radial distance between opposing sections of the inner surfaces of buffer tubes 20, which is the maximum ID decrease shown as the difference between ID1 and ID2, experienced by buffer tubes 20 for a given force F2.

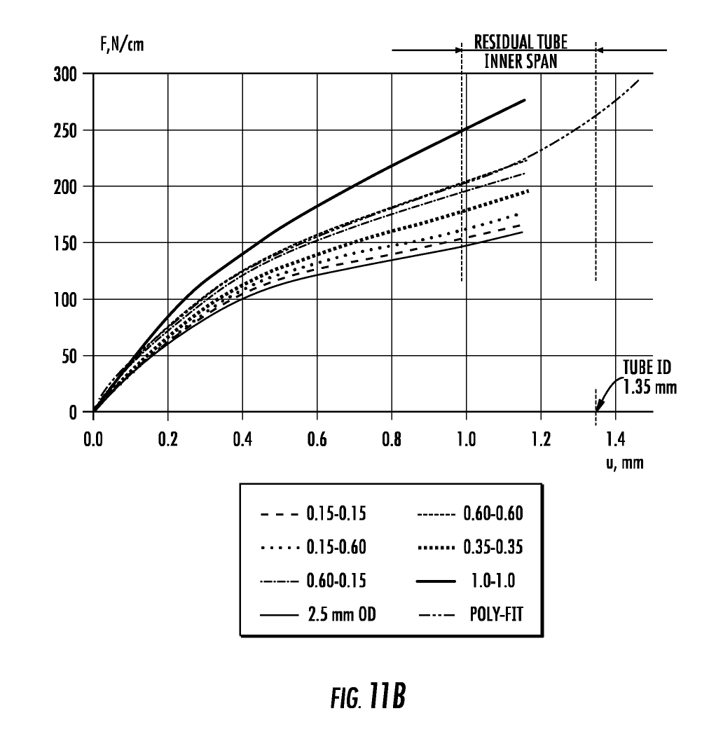

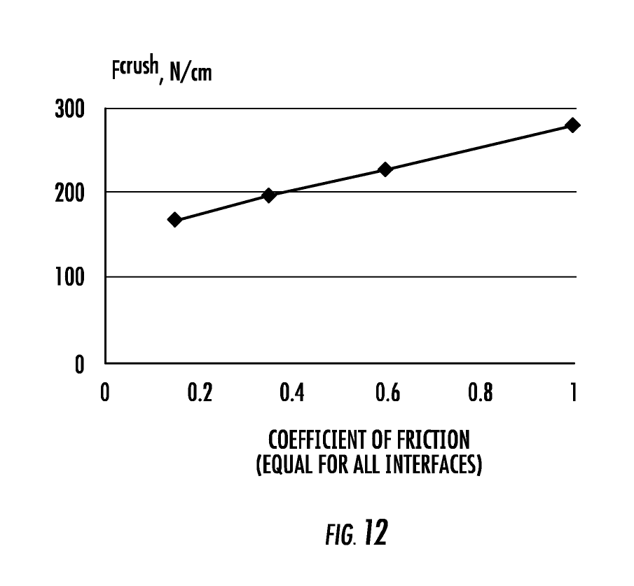

FIGS. 11A and 11B show plots representing finite element analysis showing the maximum ID decrease (FIG. 11A) and the maximum central strength member displacement (FIG. 11B) for different loading levels with a variety of interface friction levels, under a composite tension bending test. In specific embodiments, the plots of FIGS. 11A and 11B demonstrate crush performance of various cables tested using the Wringer Test. Each graph shows plots for six different cable designs with varying interface coefficient of friction values. In the legend on each graph, the first number in the pair is the coefficient of friction between outer surface 30 of buffer tubes 20 at all interfaces within cable 10 other than the interface between outer surface 30 of buffer tubes 20 and inner surface 14 of cable jacket 12. In the legend on each graph, the second number in the pair is the coefficient of friction between outer surface 30 of buffer tubes 20 and inner surface 14 of cable jacket 12.

Referring specifically to FIG. 11A, the vertical axis shows the loading applied to cable 10 in N/cm, and the horizontal axis shows the maximum ID decrease of buffer tubes 20 in millimeters. As generally shown in FIG. 11A, as the friction between the various interfaces increases, the amount of force required to collapse or distort buffer tubes 20 increases.

Referring specifically to FIG. 11B, the vertical axis shows the loading applied to cable 10 in N/cm, and the horizontal axis shows the maximum displacement of central strength member 24 in millimeters. As generally shown in FIG. 11B, as the friction between the various interfaces increases, the amount of force required to displace central strength member 24 also increases. FIG. 11B also shows the crush performance of a standard 2.5 mm outer diameter buffer tube with an assumed coefficient of kinetic friction of 0.15, labeled as 2.5 mm OD.

Accordingly, as shown in FIG. 11A, in various embodiments, the friction structure of cable 10 discussed herein increases friction such that the maximum decrease in the radial distance between opposing sections of the inner surfaces of buffer tubes 20 (i.e., the maximum ID decrease noted above) is less than 0.7 mm and greater than 0.2 mm under 150 N/cm loading as determined by the Wringer Test. In one embodiment, in which the inner tube diameter is 1.35 mm, the friction structure of cable 10 discussed herein increases friction such that the maximum decrease in the radial distance between opposing sections of the inner surfaces of buffer tubes 20 (i.e., the maximum ID decrease noted above) is less than 0.975 mm under 150 N/cm loading as determined by the Wringer Test. In various embodiments, based on the various starting inner diameters, ID1, of buffer tubes 20 as discussed above, the minimum radial distance, during compression, between opposing sections of the inner surfaces of buffer tubes 20 is greater than 0.375 mm and specifically greater than 0.5 mm under 150 N/cm loading as determined by the Wringer Test. In other embodiments, the friction structure of cable 10 increases friction such that the maximum decrease in the radial distance between opposing sections of the inner surfaces of buffer tubes 20 is less than 0.6 mm and greater than 0.2 mm, and more specifically is less than 0.5 mm and greater than 0.2 mm, under 150 N/cm loading as determined by the Wringer Test.

In addition, as shown in FIG. 11B, in various embodiments, the friction structure of cable 10 discussed herein increases friction such that the radial displacement of central strength member 24 is less than 1.0 mm and greater than 0.2 mm under 150 N/cm loading as determined by the Wringer Test. In other embodiments, the friction structure of cable 10 discussed herein increases friction such that the radial displacement of central strength member 24 is less than 0.8 mm and greater than 0.2 mm, and more specifically are less than 0.6 mm and greater than 0.2 mm, under 150 N/cm loading as determined by the Wringer Test. In another embodiment, for the displacement of central member equal to 1.15 mm, maximum load the cable will bear is between 160 N/cm and 275 N/cm as measured by the Wringer Test.

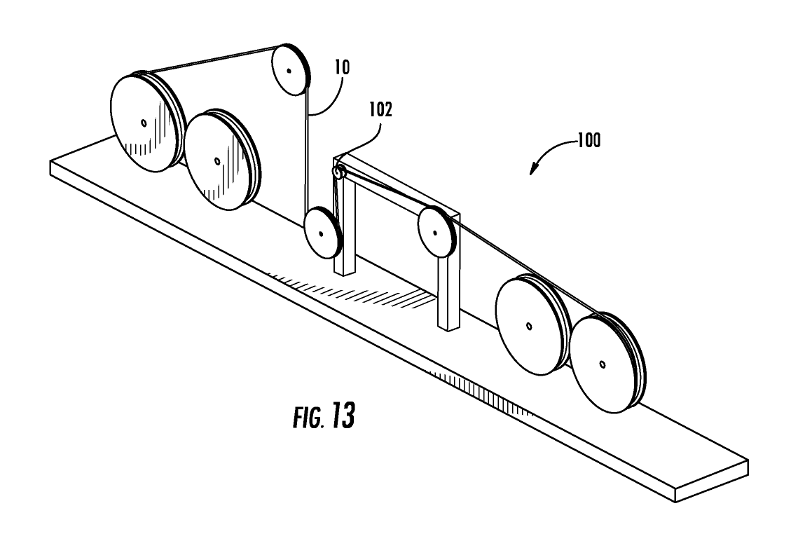

Referring to FIG. 12, a relationship between the coefficient of friction between internal surface interfaces between buffer tubes 20 and the other components of cable 10 and crush force in N per cm of tube length (tension load in N divided by the bend radius in cm) (as determined by finite element analysis) is shown according to an exemplary embodiment. In various embodiments, the coefficients of kinetic friction shown in FIG. 12 include the coefficient of friction between the outer surfaces of adjacent buffer tubes 20, between outer surfaces of buffer tubes 20 and central strength member 24, and/or between outer surfaces of buffer tubes 20 and an exterior cable layer such as jacket 12 or film binder 62. As shown in FIG. 12 as friction increases the crush resistance of cable 10 increases, as measured by crush force, shown as Fcrush, in FIG. 12.

Accordingly, as shown in FIG. 12, in various embodiments, the friction structure of cable 10 discussed herein increases friction such that the coefficient of kinetic friction at the interfaces between the outer surfaces of the buffer tubes 20 and/or between buffer tubes 20 and one of the other structures within cable 10 (such as jacket 12 and/or strength member 24) is greater than 0.15, and more specifically is greater than 0.2, as determined by the protocol defined in ASTM D1894-14. In various embodiments, the friction structure of cable 10 discussed herein increases friction such that the coefficient of kinetic friction at the interfaces between the outer surfaces of the buffer tubes 20 and/or between buffer tubes 20 and one of the other structures within cable 10 (such as jacket 12 and/or strength member 24) is greater than 0.35, as determined by the protocol defined in ASTM D1894-14. As used herein coefficients of kinetic friction are determined using the protocol defined in ASTM D1894-14. In various embodiments, the friction structures of cable 10 discussed herein increase friction such that the coefficient of kinetic friction at the interfaces between the outer surfaces of adjacent buffer tubes 20 and/or between buffer tubes 20 and one of the other structures within cable 10 (such as jacket 12 and/or strength member 24) is greater than 0.5, and more specifically is greater than 0.8.

In various embodiments, cable jacket 12 may be a variety of materials used in cable manufacturing such as medium density polyethylene, polyvinyl chloride (PVC), polyvinylidene difluoride (PVDF), nylon, polyester or polycarbonate and their copolymers. In addition, the material of cable jacket 12 may include small quantities of other materials or fillers that provide different properties to the material of cable jacket 12. For example, the material of cable jacket 12 may include materials that provide for coloring, UV/light blocking (e.g., carbon black), burn resistance, etc.

While the specific cable embodiments discussed herein and shown in the figures relate primarily to cables and core elements that have a substantially circular cross-sectional shape defining substantially cylindrical internal lumens, in other embodiments, the cables and core elements discussed herein may have any number of cross-section shapes. For example, in various embodiments, cable jacket 12 and/or the buffer tubes 20 may have a square, rectangular, triangular or other polygonal cross-sectional shape. In such embodiments, the passage or lumen of the cable or buffer tube may be the same shape or different shape than the shape of cable jacket 12 or buffer tube 20. In some embodiments, cable jacket 12 and/or buffer tube 20 may define more than one channel or passage. In such embodiments, the multiple channels may be of the same size and shape as each other or may each have different sizes or shapes.

The optical fibers discussed herein may be flexible, transparent optical fibers made of glass or plastic. The fibers may function as a waveguide to transmit light between the two ends of the optical fiber. Optical fibers may include a transparent core surrounded by a transparent cladding material with a lower index of refraction. Light may be kept in the core by total internal reflection. Glass optical fibers may comprise silica, but some other materials such as fluorozirconate, fluoroaluminate, and chalcogenide glasses, as well as crystalline materials, such as sapphire, may be used. The light may be guided down the core of the optical fibers by an optical cladding with a lower refractive index that traps light in the core through total internal reflection. The cladding may be coated by a buffer and/or another coating(s) that protects it from moisture and/or physical damage. These coatings may be UV-cured urethane acrylate composite materials applied to the outside of the optical fiber during the drawing process. The coatings may protect the strands of glass fiber.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A crush resistant optical communication cable comprising:
a cable body including an inner surface defining a channel within the cable body;
a first core element located in the channel of the cable body, the first core element comprising:
a first tube including an outer surface, an inner surface and a channel defined by the inner surface of the first tube; and
an optical fiber located within the channel of the first tube;
a second core element located in the channel of the cable body, the second core element comprising:
a second tube including an outer surface, an inner surface and a channel defined by the inner surface of the second tube; and
an optical fiber located within the channel of the second tube;
an elongate rod located in the channel of the cable body including an outer surface; and
a friction structure located within the channel of the cable increasing friction between at least two of the inner surface of the cable body, the outer surface of the first tube, the outer surface of the second tube and the outer surface of the elongate rod, wherein the friction structure increases friction such that radial displacement of the elongate rod is less than 1.0 mm and greater than 0.2 mm under 150 N/cm loading as determined by the Wringer Test.

2. The crush resistant optical communication cable of claim 1 wherein the friction structure is located along the outer surface of the first tube and along the outer surface of the second tube, wherein the first tube and second tube are not adhered together such that the second tube is permitted to move relative to the first tube within the channel.

3. The crush resistant optical communication cable of claim 2 wherein the friction structure includes a series of grit particles embedded in and extending from the outer surfaces of the first tube and the second tube.

4. The crush resistant optical communication cable of claim 2 wherein the first and second tubes are both formed from a first polymer material, wherein the friction structure includes a series of polymer projections adhered to the outer surfaces of the first tube and the second tube, wherein the polymer projections are formed from a second polymer material that is different than the first polymer material.

5. The crush resistant optical communication cable of claim 2 wherein the friction structure includes a series of grooves formed in each of the outer surfaces of the first tube and the second tube.

6. The crush resistant optical communication cable of claim 5 wherein the series of grooves of both the first tube and second tube each form an irregular, nonrepeating pattern along the outer surfaces of the first tube and second tube.

7. The crush resistant optical communication cable of claim 1 wherein the friction structure is located along the inner surface of the cable body and includes at least one of grit particles embedded in and extending from the inner surface of the cable body, polymer projections adhered to the inner surface of the cable body, and a series of grooves formed in the inner surface of the cable body.

8. The crush resistant optical communication cable of claim 1 wherein the friction structure increases friction such that the maximum decrease in the radial distance between opposing sections of the inner surfaces of the first and second tubes is less than 0.7 mm under 150 N/cm loading as determined by the Wringer Test.

9. The crush resistant optical communication cable of claim 1 wherein the friction structure creates a coefficient of kinetic friction between the inner surface of the cable body and the outer surfaces of the first and second tubes greater than 0.15 as determined under ASTM D1894-14.

10. The crush resistant optical communication cable of claim 1 wherein the first and second tubes are buffer tubes having an outer diameter of between 2.0 mm and 2.25 mm and a wall thickness between 0.25 mm and 0.35 mm, wherein the thickness of the cable body is between 1.2 and 1.5 mm.

11. An optical communication cable comprising:
a cable body including an inner surface defining a channel within the cable body;
a first buffer tube located in the channel of the cable body, the first buffer tube including an outer surface, an inner surface and a channel defined by the inner surface of the first buffer tube;
a first plurality of optical fibers located within the channel of the first buffer tube;
a second buffer tube located in the channel of the cable body, the second buffer tube including an outer surface, an inner surface and a channel defined by the inner surface of the second buffer tube;
a second plurality of optical fibers located within the channel of the second buffer tube; and
a friction structure located within the channel of the cable body that causes friction between at least two of the inner surface of the cable body, the outer surface of the first buffer tube, and the outer surface of the second buffer tube, wherein the friction structure causes friction such that minimum radial distance between opposing sections of the inner surfaces of the first and second buffer tubes is greater than 0.375 mm under 150 N/cm loading as determined by the Wringer Test;
wherein the first buffer tube and second buffer tube are not adhered together such that the second buffer tube is permitted to move relative to the first buffer tube within the channel.

12. The optical communication cable of claim 11 wherein the maximum decrease in the radial distance between opposing sections of the inner surfaces of the first and second buffer tubes is greater than 0.2 mm under 150 N/cm loading as determined by the Wringer Test, wherein the first and second tubes are formed from a polypropylene material and each have an outer diameter of between 2.0 mm and 2.25 mm and a wall thickness between 1.2 mm and 1.5 mm.

13. The optical communication cable of claim 11 wherein the friction structure is located along the outer surfaces of the first and second buffer tubes, wherein the friction structure includes at least one of a series of grit particles embedded in and extending from the outer surfaces of the first and second buffer tubes, a series of polymer projections adhered to the outer surfaces of the first and second buffer tubes, and an irregular series of grooves formed in the outer surfaces of the first and second buffer tubes.

14. The optical communication cable of claim 11 wherein the friction structure is located along the inner surface of the cable body, wherein the friction structure includes at least one of a series of grit particles embedded in and extending from the inner surface of the cable body, a series of polymer projections adhered to the inner surface of the cable body, and an irregular series of grooves formed in the inner surface of the cable body.

15. The optical communication cable of claim 11 wherein the friction structure creates a coefficient of kinetic friction between the inner surface of the cable body and the outer surfaces of the first and second buffer tubes greater than 0.15 as determined under ASTM D1894-14.

16. An optical communication cable comprising:
a cable sheath including an inner surface defining a channel within the cable sheath;
a plurality of buffer tubes located in the channel of the cable sheath, each buffer tube including an outer surface, an inner surface and a channel defined by the inner surface of the buffer tube;
a plurality of optical fibers located within the channel of each buffer tube; and
a friction structure located on at least one of the inner surface of the sheath and the outer surfaces of each of the plurality of buffer tubes, wherein the friction structure creates a coefficient of kinetic friction between the inner surface of the cable sheath and the outer surfaces of the buffer tubes greater than 0.2.

17. The optical communication cable of claim 16 wherein the coefficient of kinetic friction is a coefficient of kinetic friction greater than 0.15 as determined under ASTM D1894-14.

18. The optical communication cable of claim 16 wherein the cable sheath is an extruded film having a thickness less than 200 micrometers, and further comprising a cable jacket located outside of and surrounding the cable sheath.

19. The optical communication cable of claim 16 wherein the friction structure is located along the outer surfaces of each of the plurality of buffer tubes, wherein the friction structure includes at least one of a series of grit particles embedded in and extending from the outer surfaces of the buffer tubes, a series of polymer projections adhered to the outer surfaces of the buffer tubes, and an irregular series of grooves formed in the outer surfaces of the buffer tubes.

20. The optical communication cable of claim 16 wherein the buffer tubes each have an outer diameter of between 1.8 mm and 2.4 mm.
